(19) United States
(12) Patent Application Publication
(10) Pub. No.: US 2017/0011715 A1
(43) Pub. Date: Jan. 12, 2017

(54) METHOD, NON-TRANSITORY STORAGE MEDIUM AND ELECTRONIC DEVICE FOR DISPLAYING SYSTEM INFORMATION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SAN CHIANG, New Taipei (TW); GANG-FAN LI, Shenzhen (CN); HUA-DONG CHENG, Shenzhen (CN); LING-JUAN JIANG, Shenzhen (CN)

(21) Appl. No.: 14/834,644

(22) Filed: Aug. 25, 2015

(30) Foreign Application Priority Data
Jul. 10, 2015 (CN) 201510402575.0

(51) Int. Cl. G09G 5/377; G06F 3/0354; G06F 3/01; G06T 7/00; G06K 9/00

(52) U.S. Cl. CPC G09G 5/377; G06T 7/0044; G06K 9/00355; G06F 3/017; G06F 3/03547; G09G 2354/00; G09G 2340/12; G09G 2370/04; G09G 2320/08; G09G 2320/10; G06T 2207/30196

(57) ABSTRACT

In a method for displaying system information, a request to display system information of the electronic device is made. Then, system information to be displayed is obtained from the electronic device. A display interface for displaying the system information is generated according to the obtained system information. The obtained system information is arranged on the display interface according to a predefined way. And, the display interface containing the obtained system information is displayed.

### CROSS-REFERENCE TO RELATED APPLICATIONS

This application claims priority to Chinese Patent Application No. 201510402575.0 filed on Jul. 10, 2015, the contents of which are incorporated by reference herein.

### FIELD

The subject matter herein generally relates to computing technologies, and more specifically relates to an electronic device, a non-transitory storage medium, and a method for displaying system information.

### BACKGROUND

Generally, electronic devices such as mobile phones or tablet computers display system information on a top right corner, for example current time, data, capacity of battery, a WIFI signal mark, and so on.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a system information display system.

FIG. 2 is a block diagram of one embodiment of function modules of the system information display system in FIG. 1.

FIG. 3 is a flowchart of one embodiment of a method for displaying system information.

FIG. 4 is a diagrammatic view of one embodiment of a system information display interface.

FIG. 5 is a flowchart of one embodiment of the block 32 in FIG. 3.

FIG. 6 is a flowchart of an alternative embodiment of the block 32 in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

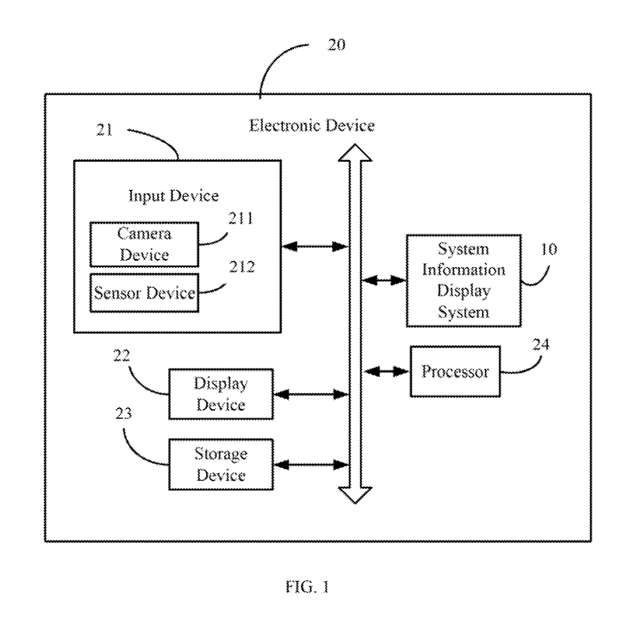

FIG. 1 is a block diagram of one embodiment of a hardware environment for executing a system information display system. The system information display system 10 is installed and runs in an apparatus, for example an electronic device 20. In at least one embodiment as shown in FIG. 1, the electronic device 20 includes, but is not limited to, an input device 21, a display device 22, a storage device 23, and at least one processor 24. The electronic device 20 can be a tablet computer, a notebook computer, a smart phone, a personal digital assistant (PDA), or other suitable electronic device. FIG. 1 illustrates only one example of the electronic device; others can include more or fewer components than illustrated, or have a different configuration of the various components in other embodiments.

The system information display system 10 can obtain system information to be displayed from the electronic device 20 when a request to display system information of the electronic device is received. The system information display system 10 can generate a display interface for displaying the system information according to the obtained system information and arrange the obtained system information on the display interface according to a predefined way. The system information display system 10 further displays the interface containing the obtained system information.

In at least one embodiment, the input device 21 can be a mouse, a keyboard, or a touch panel, for generating signals in response to input operations. The display device 22 can display system information and can be a display screen. The storage device 23 can include various types of non-transitory computer-readable storage mediums. For example, the storage device 23 can be an internal storage system, such as a flash memory, a random access memory (RAM) for temporary storage of information and/or a read-only memory (ROM) for permanent storage of information. The storage device 23 can also be an external storage system, such as a hard disk, a storage card, or a data storage medium. The at least one processor 24 can be a central processing unit (CPU), a microprocessor, or other data processor chip that performs functions of the system information display system 10 in the electronic device 20.

In one embodiment, the input device 21 can be a camera device 211. The camera device is electronically connected with the processor 24, and can capture consecutive images of a hand movement. The captured images are stored in the storage device 23 according to a captured time. The images are formed by a gesture input operation. In an alternative embodiment, the input device 21 can be a sensor device 212, such as an optical sensor. The sensor device can sense slide operations applied on the electronic device 20. In another embodiment, the sensor device 212 is a distance sensor and can sense a distance from a user to the electronic device 20.

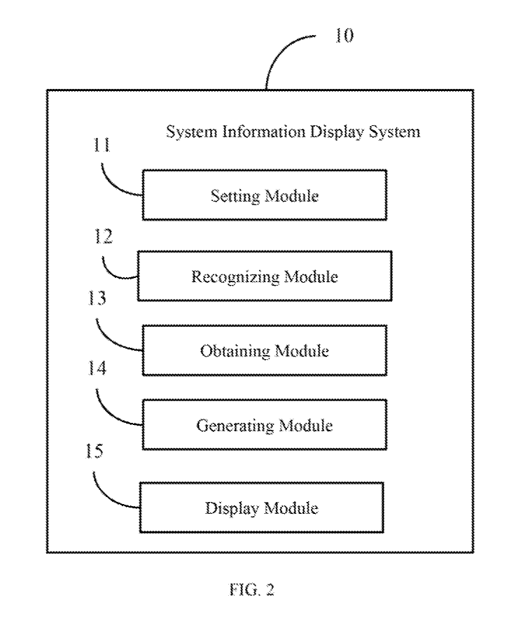

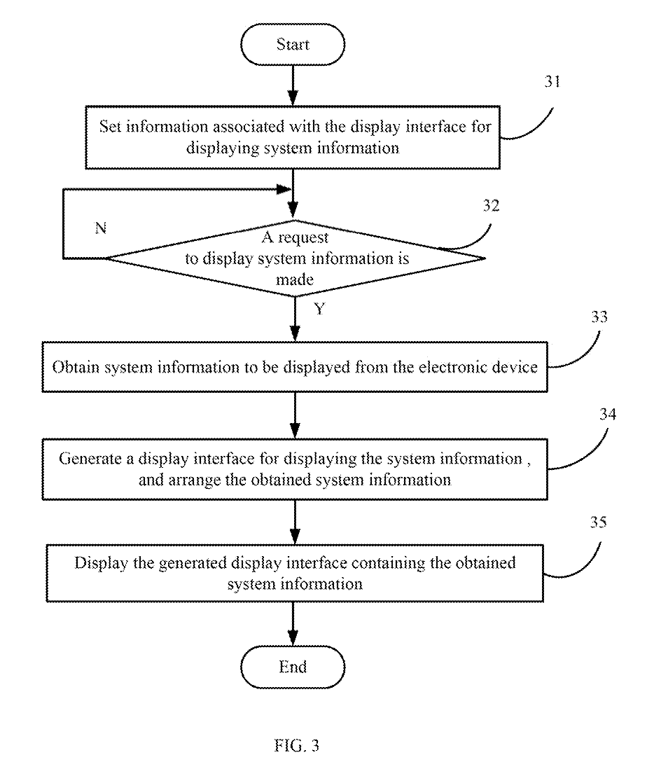

FIG. 2 is a block diagram of one embodiment of the function modules of the system information display system 10. In at least one embodiment, the system information display system 10 can include a setting module 11, a recognizing module 12, an obtaining module 13, a generating module 14, and a display module 15. The function modules 11-15 can include computerized codes in the form of one or more programs, which are stored in the storage device 23. The at least one processor 24 executes the computerized codes to provide functions of the function modules 11-15. A detailed description of the functions of the modules 11-15 is given below in reference to FIGS. 3, 5 and 6.

FIG. 3 is a flowchart of one embodiment of a method for displaying system information. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Further, the illustrated order of blocks is by example only and the order of the blocks can change. The exemplary method 300 can begin at block 31. Depending on the embodiment, additional steps can be added, others removed, and the ordering of the steps can be changed.

At block 31, the set module sets information associated with the display interface for displaying system information in response to input operation.

In the illustrated embodiment, the information associated with the display interface can include, but is not limited to, content of system information to be displayed on the display interface; a duration each time the display interface displays, such as 5 seconds; a display pattern of information system on the display interface, and a condition under which the request to display system information of the electronic device is made.

The content of system information includes, but is not limited to, current time, date, capacity of battery, network signal, a usage of the processor, and a usage of memory. The content of system information can be set according to need. The duration each time the display interface displays is 5 seconds, for example. When the duration is expired, the system information display system 10 can close or hide the display interface. The display pattern includes text size and an arrangement pattern of system information associated with the size. In one embodiment, the content of the system information is displayed in a first size, and the arrangement pattern associated with the first size is 4 lines and 6 columns. That is, six columns are displayed on the display interface, and four classes of system information are displayed in a column. In an alternative embodiment, the content of the system information is displayed in a second size, and the arrangement pattern associated with the second size is 2 lines and 3 columns. The second size is greater than the first size. That is, three columns are displayed on the display interface, and two classes of system information are displayed in a column.

In one embodiment, the condition, under which the request is deemed to be made, to be a predefined slide operation or a predefined gesture operation is applied to the electronic device 20. In an alternative embodiment, the condition also can be a prompt message associated with content of the system information, for example, notifications, system error messages, a low battery message, network connection information, and the like. In other embodiments, the condition can be that, but is not limited to, the display device of the electronic device 20 is under a locked status, or a distance from the user to the electronic device 20 is less than or equal to a predefined distance.

At block 32, the recognizing module recognizes whether a request to display system information of the electronic device is made. If yes, the process goes to block 33; if no, the process goes back to block 32.

In one embodiment, when the camera device 211 captures images of a predefined gesture operation, the recognizing module 12 determines the request is made. In an alternative embodiment, when the sensor device 212 senses a predefined slide operation on the electronic device 20, the recognizing module 12 recognizes the request is made. In one embodiment, the sensor device 212 senses a distance from a finger of a user to the electronic device 20 is less than or equals a predefined distance, the recognizing module 12 recognizes the request is made. In other embodiments, when electronic device 20 is under a status of locked screen or receiving system messages, the recognizing module 12 recognizes the request is made.

At block 33, the obtaining module obtains system information to be displayed from the electronic device.

At block 34, the generating module generates a display interface for displaying the system information according to the obtained system information, and arranges the obtained system information on the display interface according to a predefined way.

At block 35, the display module displays the generated display interface containing the obtained system information.

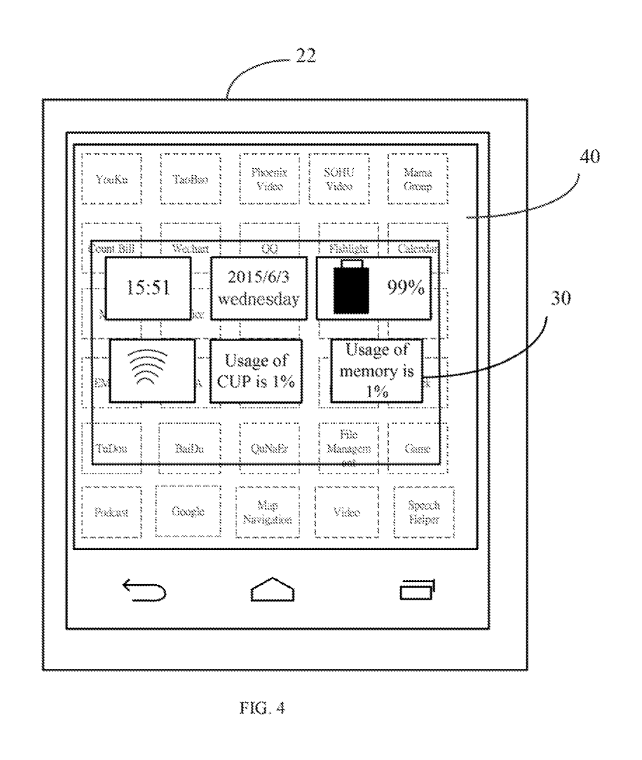

FIG. 4 illustrates a display interface according to one embodiment. The display interface 30 includes six classes system information, such as current time, date, capacity of battery, network signal, a usage of the CPU, and a usage of memory. In the illustrated embodiment, a current page 40 is displayed on the display device 22. The display module 15 simultaneously displays the display interface 30 and the current page 40. In one embodiment as illustrated in FIG. 4, the display module 15 can dimly display the current page 40 and highlight the display of the display interface 30 which is displayed over the current page 40. In an alternative embodiment, the display module 15 can control the display interface 30 to be transparent and displayed over the current page 40. Therefore, the display interface 30 is displayed on the display device 22 and will not affect content contained in the current page 40 as seen by the user.

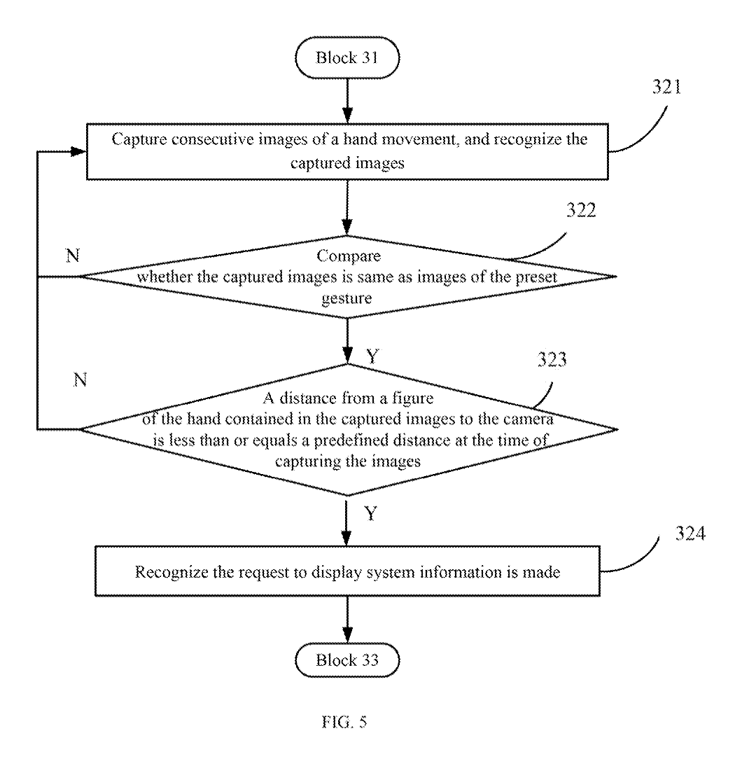

FIG. 5 illustrates a detail flowchart of one embodiment of the block 33 in FIG. 3. The example method 500 is provided by way of example, as there are a variety of ways to carry out the method. The method 500 described below can be carried out using the configurations illustrated in FIGS. 1 and 2, for example, and various elements of these figures are referenced in explaining example method 500. Each block shown in FIG. 5 represents one or more processes, methods or subroutines, carried out in the exemplary method 500. Moreover, the illustrated order of blocks is by example only and the order of the blocks can change. The exemplary method 500 can begin at block 321. Depending on the embodiment, additional steps can be added, others removed, and the ordering of the steps can be changed.

At block 321, the camera device captures consecutive images of a hand movement; the recognizing module recognizes the captured images.

In one embodiment, the recognizing module 12 can gray each captured image and get a grayscale image associated with the captured image.

In the illustrated embodiment, assume a size of a captured image P is W*L, and grayscale value of the image P can be M1, M2, M3 . . . ML. A random variable N denotes a pixel of an image Rxy, the value range of parameter x is from 1 to W the value range of parameter y is from 1 to L. In the case, the image P is described based on the probability distribution of the grayscale values and probability of each grayscale value is different. Assume, the probability of each grayscale value of image P is: P1=P(M1), P2=P(M2), P3=P(M3), . . . , PN=P(ML); and P(M1)+P(M2)+P(M3), . . . , +P(ML)=1. Then, the image P can be described as a following grayscale density matrix:

$$( \begin{matrix}N \\ P ( N )\end{matrix} ) = ( \begin{matrix}M 1 , M 2 , … ML \\ P 1 , P 2 , … PL\end{matrix} ) .$$

It is not hard to understand, each image has its own grayscale density matrix.

In the grayscale processing, the recognizing module 12 selects grayscale values that are greater than a predefined value from the grayscale density matrix of the image to get the grayscale image associated with the image.

Take the image P for example; assuming the predefined grayscale value is P0, and, In the illustrated embodiment, only grayscale values of P1, P2, and P3 are greater than P0, then, the grayscale density matrix of the image P is

$$( \begin{matrix}3 \\ P ( 3 )\end{matrix} ) = ( \begin{matrix}M 1 , M 2 , M 3 \\ P 1 , P 2 , P 3\end{matrix} ) .$$

At block 322, the recognizing module 12 compares whether the captured images is the same as images of the preset gesture. If yes, the process goes to block 323; if no, the process goes back to block 321.

In the illustrated embodiment, the storage device 23 pre-stores grayscale images associated with the images of the preset gesture. The recognizing module 12 compares grayscale images of the captured images with grayscale images of the preset gesture, and further determines whether a similarity degree between the grayscale images of the captured images and grayscale images of the preset gesture is greater than a predefined value. If yes, the recognizing module 12 determines the captured images are the same as images of the preset gesture.

At block 323, the recognizing module recognizes whether a distance from a finger of the hand contained in the captured images to the camera is less than or equal to a predefined distance at the time of capturing the images. If yes, the process goes to block 324; if no, the process goes back to block 321.

In the illustrated embodiment, the storage device 23 pre-stores a sheet. The sheet defines relationships between sizes of a finger contained in images, clarity of the images, and distances from the finger to the camera when capturing the images. The recognizing module 12 calculates the distance from the finger to the camera at the time of capturing the images according to a formula D=P*Q+K*S, wherein, P denotes pixels of an image, Q denotes an adjustable parameter of the pixels of the image, K denotes the size of the finger contained in the image, S denotes an adjustable parameter of the size of the finger.

Block 324, the recognizing module 12 recognizes the request to display system information is made.

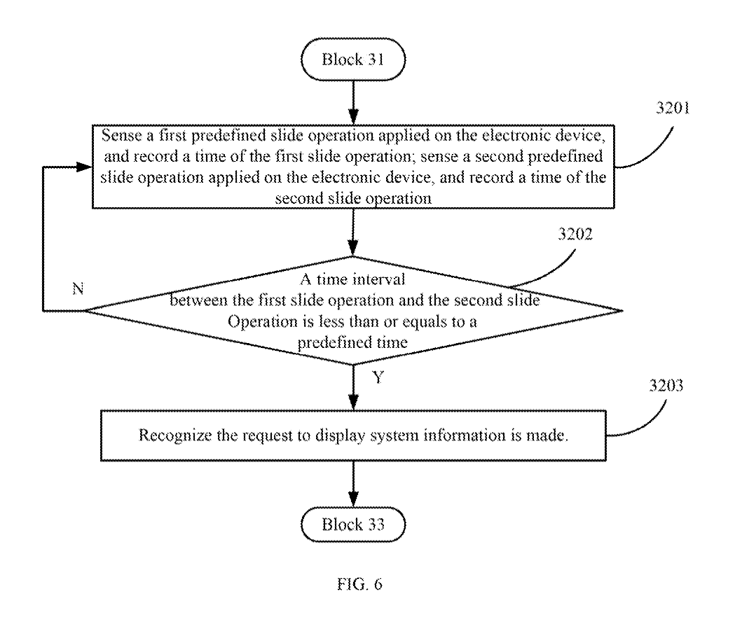

FIG. 6 illustrates a detail flowchart of an alternative embodiment of the block 33 in FIG. 3. The example method 600 is provided by way of example, as there are a variety of ways to carry out the method. The method 600 described below can be carried out using the configurations illustrated in FIGS. 1 and 2, for example, and various elements of these figures are referenced in explaining example method 600. Each block shown in FIG. 6 represents one or more processes, methods or subroutines, carried out in the exemplary method 600. Moreover, the illustrated order of blocks is by example only and the order of the blocks can change. The exemplary method 600 can begin at block 3201. Depending on the embodiment, additional steps can be added, others removed, and the ordering of the steps can be changed.

At block 3201, the sensor device senses a first predefined slide operation applied on the electronic device, and records a time of the first slide operation; senses a second predefined slide operation applied on the electronic device, and records a time of the second slide operation.

At block 3202, the recognizing module determines a time interval between the first slide operation and the second slide operation is less than or equal to a predefined time. If yes, the process goes to block 3203; if no, the process goes back to block 3201.

At block 3203, the recognizing module 12 recognizes the request to display system information is made.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for displaying system information, executable by at least one processor of an electronic device, the method comprising:
obtaining system information, when a request to display system information of the electronic device is made, to be displayed from the electronic device;
generating a display interface for displaying the system information according to the obtained system information;
arranging the obtained system information on the display interface according to a predefined way; and
displaying the display interface containing the obtained system information over the current page of the electronic device.

2. The method according to claim 1, further comprising:
setting information associated with the display interface, wherein the information comprises content of system information to be displayed on the display interface, a duration when the display interface is displaying each time, a display pattern of information system on the display interface, ways of information system arranged on the display interface, and a condition under which the request to display system information of the electronic device is deemed to be received.

3. The method according to claim 2, wherein the condition is that a predefined operation is sensed to be applied on the electronic device.

4. The method according to claim 3, wherein the electronic device comprises a camera device for capturing consecutive images of a hand movement, the consecutive images forms a gesture operation; and the condition is a preset gesture operation is applied on the electronic device.

5. The method according to claim 4, further comprising:
capturing consecutive images of a hand movement;
recognizing the captured images;
comparing whether the captured images is same as images of the preset gesture;
determining whether a distance from a finger of the hand contained in the captured images to the camera is less than or equals a predefined distance at the time of capturing the images when the captured images is same as images of the preset gesture; and
recognizing the request to display system information of the electronic device is made when the distance from a finger of the hand contained in the captured images to the camera is less than a predefined distance at the time of capturing the images.

6. The method according to claim 5, wherein each captured image is recognized by:
graying the image and getting a grayscale image associated with the captured image.

7. The method according to claim 6, wherein “comparing whether the captured images is same as images of the preset gesture” comprises:
comparing grayscale images of the captured images with grayscale images of the preset gesture;
determining whether a similarity degree between the grayscale images of the captured images and grayscale images of the preset gesture is greater than a predefined value;
determining the captured images is same as images of the preset gesture when the similarity degree between the captured images and images of the preset gesture is greater than a predefined value.

8. The method according to claim 5, further comprising:
obtaining a clarity of the image and a size of the finger contained in the captured image;
calculating the distance from the finger to the camera at the time of capturing the images according to a formula D=P*Q+K*S, wherein P denotes pixels of an image, Q denotes an adjustable parameter of the pixels of the image, K denotes the size of the finger contained in the image, S denotes an adjustable parameter of the size of the finger.

9. The method according to claim 3, wherein the electronic device comprises a sensor device, the sensor device senses a slide operation applied on the electronic device, the condition is that a predefined slide operation is sensed to be applied on the electronic device.

10. The method according to claim 9, further comprising:
sensing a first predefined slide operation applied on the electronic device, and recording a time of the first slide operation;
sensing a second predefined slide operation applied on the electronic device, and recording a time of the second slide operation;
determining a time interval between the first slide operation and the second slide operation is less than or equals to a predefined time; and
recognizing the request to display system information is made when the time interval between the first slide operation and the second slide operation is less than or equals to a predefined time.

11. The method according to claim 2, wherein the condition is that a prompt message associated with content of the system information is received.

12. The method according to claim 2, wherein the condition is a screen device of the electronic device is locked.

13. The method according to claim 1, further comprising: determining whether the request to display system information of the electronic device is made.

14. An electronic device, comprising:
a processor; and
a storage device that stores one or more programs which, when executed by the at least one processor, cause the at least one processor to:
obtaining system information, when a request to display system information of the electronic device is made, to be displayed from the electronic device;
generating a display interface for displaying the system information according to the obtained system information;
arranging the obtained system information on the display interface according to a predefined way; and
displaying the display interface containing the obtained system information over the current page of the electronic device.

15. The electronic device according to claim 14, further comprising:
setting information associated with the display interface, wherein the information comprises content of system information to be displayed on the display interface, a duration when the display interface is displaying each time, a display pattern of information system on the display interface, ways of information system arranged on the display interface, and a condition under which the request to display system information of the electronic device is deemed to be received.

16. The electronic device according to claim 15, wherein the condition is that a predefined operation is sensed to be applied on the electronic device.

17. The electronic device according to claim 16, wherein the electronic device comprises a camera device for capturing consecutive images of a hand movement, the consecutive images forms a gesture operation; and the condition is a preset gesture operation is applied on the electronic device.

18. The electronic device according to claim 17, further comprising:
capturing consecutive images of a hand movement;
recognizing the captured images;
comparing whether the captured images is same as images of the preset gesture;
determining whether a distance from a finger of the hand contained in the captured images to the camera is less than or equals a predefined distance at the time of capturing the images when the captured images is same as images of the preset gesture; and
recognizing the request to display system information of the electronic device is made when the distance from a finger of the hand contained in the captured images to the camera is less than a predefined distance at the time of capturing the images.

19. A non-transitory storage medium having stored thereon instructions that, when executed by a processor of an electronic device, causes the processor to perform a management method, wherein the method comprises:
obtaining system information to be displayed from the electronic device when a request to display system information of the electronic device is made;
generating a display interface for displaying the system information according to the obtained system information;
arranging the obtained system information on the display interface according to a predefined way; and
displaying the display interface containing the obtained system information over the current page of the electronic device.
